(19) United States
(12) Patent Application Publication
(10) Pub. No.: US 2023/0280809 A1
(43) Pub. Date: Sep. 7, 2023

(54) METHOD AND APPARATUS TO CONTROL POWER SUPPLY RAILS DURING PLATFORM LOW POWER EVENTS FOR ENHANCED USB-C USER EXPERIENCE

(71) Applicants: Venkataramani GOPALAKRISHNAN, Folsom, CA (US); Chuen Ming TAN, Bayan Lepas (MY); Charuhasini SUNDER RAMAN, Bangalore (IN); Philip R. LEHWALDER, Hillsboro, OR (US); N V S Kumar SRIGHAKOLLAPU, Bangalore (IN)

(72) Inventors: Venkataramani GOPALAKRISHNAN, Folsom, CA (US); Chuen Ming TAN, Bayan Lepas (MY); Charuhasini SUNDER RAMAN, Bangalore (IN); Philip R. LEHWALDER, Hillsboro, OR (US); N V S Kumar SRIGHAKOLLAPU, Bangalore (IN)

(21) Appl. No.: 17/684,338

(22) Filed: Mar. 1, 2022

(51) Int. Cl. G06F 1/26; H02J 9/00; G06F 1/3296

(52) U.S. Cl. CPC G06F 1/266; H02J 9/005; G06F 1/3296

(57) ABSTRACT

Embodiments herein relate to a computer which operates in a normal power mode, a full low power mode and a modified low power mode. A power supply unit (PSU) includes main power rails and a standby power rail. An intelligent decision is made as to when to turn on and off the main power rails based on the needs of connected devices such as USB Type-C devices. Power Delivery controllers communicate with the USB devices to determine their power consumption needs, and the total power consumption is aggregated at an embedded controller. If the total exceeds an available power budget, the PSU is controlled to allow for a modified low power mode in which full power is maintained at the main power rails while non-essential internal components are turned off.

### FIELD

The present application generally relates to the field of power supplies for computing devices, and more specifically, to a reduced-power state which allows charging of external Universal Serial Bus (USB) devices.

### BACKGROUND

Computing devices such as desktop personal computers (PCs) use a power supply circuit to convert AC power, typically at 110 V, to DC power at lower voltages such as 3.3 V, 5 V and 12 V. Power is consumed by various components of the computer such as a central processing unit (CPU) or other processor, other internal integrated circuits, a display device and volatile memory. When the user has not provided any input to the computer for a period of time, the computer may transition from an awake state to a sleep state in which the power supply circuit provides a reduced power output. This power output is sufficient to perform minimal functions such as refreshing the volatile memory to allow the computer to subsequently return to the wake state. However, the reduced power output may not be sufficient to power external devices which are connected to the computer via USB ports of the computer.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 illustrates an example computer in accordance with various embodiments.

FIG. 2 depicts a flowchart of an example process for providing power in the computer of FIG. 1 in accordance with various embodiments.

FIG. 3 illustrates an example implementation of a circuit in the computer 100 of FIG. 1 for implementing the process of FIG. 2, in accordance with various embodiments.

FIG. 4A illustrates example signals consistent with the process of FIG. 2 and the computer implementation of FIG. 3 in accordance with various embodiments, where there is a transition from an awake state to a modified low power state and back to the awake state.

FIG. 4B illustrates example signals consistent with the process of FIG. 2 and the computer implementation of FIG. 3 in accordance with various embodiments, where there is a transition from a full low power state to a modified low power state and back to the full low power state.

FIG. 5 illustrates an example of components that may be present in a computing system 550 for implementing the techniques (e.g., operations, processes, methods, and methodologies) described herein.

### DETAILED DESCRIPTION

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

As mentioned at the outset, various challenges and limitations are presented in powering external devices which are connected to USB ports of a computer. Computers such as a desktop computer can operate in various power-consuming states. For example, the Advanced Configuration and Power Interface (ACPI) specification defines multiple power states for computing systems. The following discussion lists the ACPI power states from highest to lowest power consumption.

S0 is a working state in which the system is fully usable and awake.

S0 low-power idle is a Sleep state, also referred to as a Modern Standby state in some System on a Chip (SoC) systems. In the Modern Standby state, the system can quickly switch from a low-power state to high-power state to respond to hardware and network events. Systems that support Modern Standby generally do not use S1-S3. A low/reduced power state uses less power than the awake state.

S1, S2 and S3 are Sleep states in which the system appears to be off. Power consumed in these states is less than in S0 and more than in S4. S3 consumes less power than S2, and S2 consumes less power than S1. Systems typically support one of these three states rather than all three. In these states (S1-S3), volatile memory such as RAM is kept refreshed to maintain the system state. Some components remain powered so the computer can wake in response to an input from a keyboard, Local Area Network (LAN), or a USB device, for instance.

S4 is a Hibernate state in which the system appears to be off and power consumption is reduced to the lowest level. The system saves the contents of volatile memory to a hibernation file to preserve the system state. Some components remain powered so the computer can wake from input from the keyboard, LAN, or a USB device.

S5 is a Soft Off state in which the system appears to be off. This state is comprised of a full shutdown and boot cycle.

G3 is a Mechanical Off state. The system is completely off and consumes no power. The system returns to the working state only after a full reboot.

Modern Standby and S1-S3 are two different power models for personal computers (PCs). The S3 power model is an older standard and requires additional time to transition to the awake state (S0) compared to Modern Standby. Modern Standby allows the operating system (OS) to manage network connectivity while in standby.

Sx is a general term for any S state and often refers to a low power state, e.g., S1-S5, which is a state other than S0. S3 systems support S0, S3, S4, S5 and G3, while Modern standby systems support S0, Modern standby (MS), S4, S5 and G3. The MS state is entered from S0 due to inactivity. The conditions for entering a particular Sx state depend on a policy. An Sx state can be entered after some time of inactivity, such as when the computer is using a battery, or the policy can state that an Sx state is entered only when the user explicitly specifies that action. There are also policy options to support entry after inactivity for both cases in the operating system (OS). The user can set this at the OS level.

A computer may have main power rails which provide sufficient power for all internal and external components in the awake state, and a standby power rail which provides a reduced amount of power for selected internals components such as RAM in a low power state. However, when the computer enters the low power state, there may not be sufficient power available to power connected external devices such as portable devices, smartphones, tablets, laptops, security cameras, speakers, and smart home devices. One solution is for the computer to remain in the fully awake state (S0), but this does not allow for reducing power consumption even when the user is not using the computer. Another solution is to increase the capacity of the standby power rails. However, this is costly and inefficient.

Techniques disclosed herein address the above and other issues. The techniques allow an intelligent decision to be made as to when to turn on and off the main power rails of a power supply of a computer based on the needs of the connected devices. In one approach, the power supply is controlled to allow for a low power state in which full power is maintained at the USB ports when needed. The techniques can include determining whether the power consumption of the connected devices exceeds a threshold or allocated power budget which requires the full power to be maintained. If the power consumption does not exceed the threshold, the computer can enter a low power state in which power is provided to the connected devices from the standby power rails instead of the main power rails. Also in the low power state, internal components are turned off except for essential components such as RAM which are needed to subsequently return the computer to the awake state. If the power consumption exceeds the threshold, the computer can continue to supply power to the connected devices from the main power rails even while the non-essential internal components remain turned off.

In one possible approach, the computer can communicate with the connected devices to determine their power consumption requirements. The computer can aggregate the power consumption requirements and compare the total to the threshold.

In an example implementation, a power supply unit (PSU) of the computer provides power on the main power rails in both an awake state and a modified low power state. The PSU provides power on the standby power rail in a full low power state while the main power rails are turned off. Further, the power on the standby rail may be lower than that provided on any of the main power rails.

The techniques are particularly suitable for desktop computers with USB Type-C (USB-C) ports which are commonly used for charging mobile devices. USB-C is an industry-standard connector for transmitting both data and power on a single cable. Desktop computers commonly follow an ATX (Advanced Technology eXtended) motherboard and power supply configuration specification. In a particular embodiment, when the desktop system enters a sleep state, the ATX main rails get turned off, forcing the power available from the Type-C ports to reduce to default power levels. The limited power available from the ATX standby rail (when main rails are off) may be insufficient to perform adequate charging on the user's mobile devices, resulting in very slow or no charging at all.

The techniques disclosed herein address the above and other challenges of platforms which are designed to shut down the main rails in low power states. In an example implementation, a solution is provided in both software and hardware.

The above and other advantages are discussed further below.

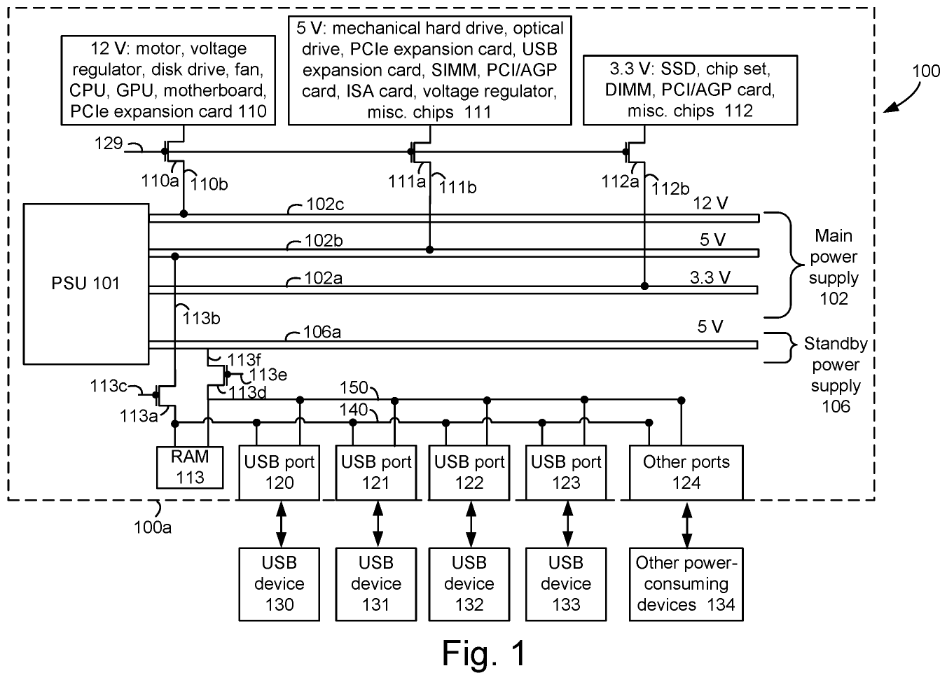

FIG. 1 illustrates an example computer 100 in accordance with various embodiments. The computer can be a PC such as a desktop computer. A desktop computer can be in the form, e.g., of a tower which is connected to a separate monitor and input devices such as a keyboard and mouse, or an all-in-one machine which includes an integrated monitor. A desktop computer includes a motherboard which is the main circuit board for the computer.

Parts of a motherboard include power and data connectors, capacitors, heat sinks, fans and expansion slots following the Peripheral Component Interconnect Express (PCIe) standard. Motherboard components plug into the motherboard either directly or with wires. These can include optical drives, such as DVD and CD-ROM, video cards and GPUs, sound cards, hard drives (SSD or HDD), processors (CPU) and memory sticks (RAM). Desktop computers are distinguished from laptop computers in that desktops require a constant connection to alternating current (AC) utility power to function. A Power Supply Unit (PSU) 101 is used to convert the AC power, such as 120 V at 60 Hz into direct current (DC) at one or more lower voltages. The conversion can use DC/DC converters.

The PSU provides the DC power on one or more power rails. A power or voltage rail refers to a single voltage provided by the PSU. In this example, the DC power can be provided at 3.3 V, 5 V and 12 Von main power rails 102a, 102b and 102c, respectively, as part of a main power supply 102. The DC power can also be provided at 5 V, for example, on a standby power rail 106a as part of a standby power supply 106. In one approach, the main power supply but not the standby power supply is active when the computer is in an awake state or in a modified low power state, and the standby power supply but not the main power supply is active when the computer is in a full low power state. These states are discussed in further detail below. It is also possible for both the main and standby power supplies to be available when the computer is in the awake and the modified low power states.

A PSU may conform to the ATX specification, in one example approach. The example main power rails at 3.3 V, 5 V and 12 V can have associated maximum currents such as 34, 35 and 28 A, for a maximum power of 112.2, 175 and 336 W, respectively in an example 480 W PSU. The power output of the PSU can be sized based on the needs of the computer. Further, a maximum current of 2 A may be provided on the standby rail for a maximum power of 10 W. A power rail at −12 V, not depicted, may also be provided with a maximum current of 1 A for a maximum power of 12 W. Generally, in the S0 or awake state, the PSU has a capability that is sufficient to power the system for all intended usages.

Various internal components of the computer can draw power from the main power supply. For example, a set of components 110 draw a relatively large amount of power and are powered by the 12 V rail 102c. These include, e.g., a motor, a voltage regulator, a disk drive, a fan, a CPU, a graphics processing unit (GPU), a motherboard and a PCIe expansion card. A set of components 111 draw a moderate amount of power and are powered by the 5 V rail 102b. These include, e.g., a mechanical hard drive, an optical drive, a PCIe expansion card, a USB expansion card, a single in-line memory module (SIMM), a Peripheral Component Interconnect (PCI)/Accelerated Graphics Port (AGP) card, an Industry Standard Architecture (ISA) card, a voltage regulator and misc. (miscellaneous) chips. A set of components 112 draw a relatively small amount of power and are powered by the 3.3 V rail 102a. These include, e.g., a solid-state drive (SSD), a chip set, a dual in-line memory module (DIMM), a PCI/AGP card and misc. chips. Some types of components can be powered by different voltages as noted.

The sets of components 110, 111 and 112 can be connected to the main power supply rails 102c, 102b and 102a, respectively, via transistors 110a, 111a and 112a, respectively, and paths 110b, 111b and 112c, respectively. The transistors have their control gates connected to a path 130 so that they can be turned on or off together, in one approach. As a simplification, one transistor/switch is depicted for each set of components. In another implementation, a separate transistor is provided for each individual component. In one approach, the transistors are turned on (made conductive) when the computer is in the awake state but not when the computer is in a full or modified low power state. When the transistors 110a-112a are turned on, the sets of components 110-112 draw power from the main power supply. When the transistors 110a-112a are turned off (made non-conductive), the sets of components 110-112 do not draw power. The sets of components 110-112 may be considered to be non-essential since they are not required to return to the awake state from a lower power state is entered.

A random access memory (RAM) 113 is powered by the 5 V rail 102b of the main power supply or the 5 V rail 106a of the standby power supply depending on the mode. The RAM requires continuous power to retain state information of the computer which allows to it quickly transitions to the awake state from a lower powered state. The RAM is therefore an essential component in this example. The RAM is connected to the rail 102b via a transistor 113a and path 113b, and to the rail 106a via a transistor 113d and path 113f. Control gates of the transistors 113a and 113d are connected to paths 113c and 113e, respectively, where appropriate control signals can be applied to turn the transistors on or off.

The RAM is continuously powered, in both the awake state and the low power states to retain its data. When transitioning from a low power state in which the sets of components 110-112 are depowered, data in the RAM is used to return the computer to the awake state. When the transistor 113a is turned on and the transistor 113d is turned off, e.g., in an awake state of the computer, the RAM draws power from the main power supply. When the transistor 113a is turned off and the transistor 113d is turned on, e.g., in a low power state of the computer, the RAM draws power from the standby power supply.

The computer 100 also includes a number of USB ports 120-123 which may be connected to external USB devices 130-133, respectively. This example includes four USB ports, but any number of one or more USB ports may be provided. A USB port can provide both data and power transfer. A newer type of USB, USB Type-C, is expected to replace prior versions such as USB Type-A and USB Type-B. USB Type-C can handle data, power, and video transmissions. It is a 24-pin USB connector system with a rotationally symmetrical connector. USB-C devices typically consume a maximum current of 900 mA at 5 V, for a maximum power consumption of 4.5 W.

The external USB devices can include, e.g., portable devices, smartphones, tablets, laptops, security cameras, speakers, and smart home devices.

The computer may also include other ports 124 which are connected to other power-consuming devices 134. For example, these devices can include auxiliary accessories such as speakers, a keyboard, an external monitor, a mouse, and other devices. Generally, a computer port is a connection point or interface between a body of the computer and an external device. The ports are typically located at a periphery or edge of the body 100a.

The USB ports and other ports can be connected to the main power supply rail 102b via the transistor 113a and to the standby power rail 106a via the transistor 113d, in one approach. In another approach, each port is connected to the main power supply and the standby power rail via respective transistors. The USB ports and other ports are connected to the transistors 113a and 113d via paths 140 and 150, respectively.

The RAM, USB ports and other ports are connected to the main power supply and disconnected from the standby power supply, e.g., in an awake state or a modified low power state, when the transistor 113a is turned on and the transistor 113d is are turned off. The RAM, USB ports and other ports are connected to the standby power supply and disconnected from the main power supply in a full low power state when the transistor 113a is turned off and the transistor 113d is turned on.

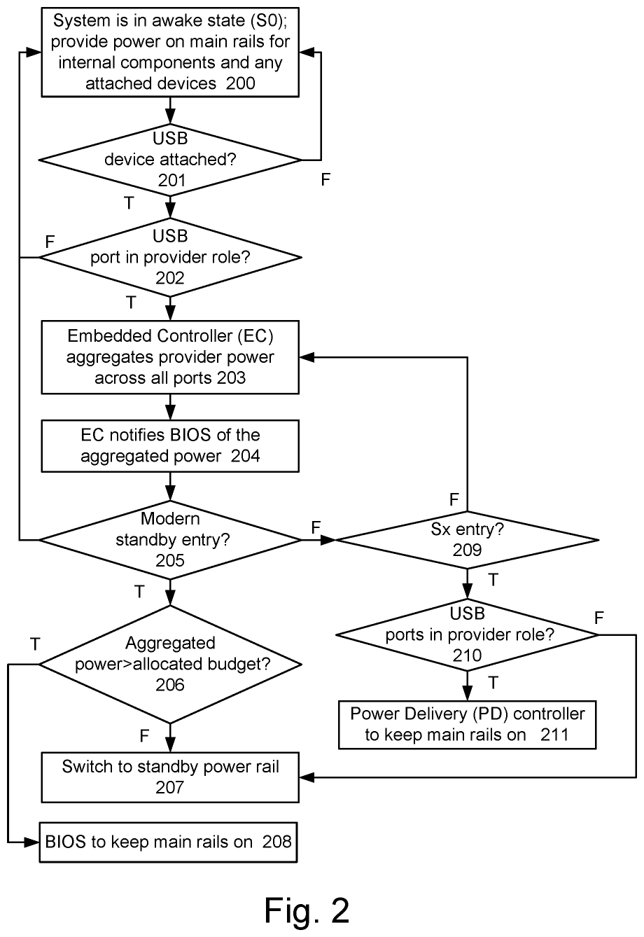

FIG. 2 depicts a flowchart of an example process for providing power in the computer of FIG. 1 in accordance with various embodiments. At step 200, the system (computer) is in an awake state, e.g., S0. The step includes providing power on the main rails for the internal components and any attached devices. A decision step 201 determines whether a USB device is attached. In one approach, this involves determining whether a USB Type-C device is attached. The computer can include Power Delivery (PD) controllers which communicate with the external devices to determine the type of device. If the decision step 201 is false (F), the process continues at step 200. If the decision step 201 is true (T), a decision step 202 determines whether the USB port or ports are in a provider role, e.g., delivering power to a respective USB device. If the decision step 202 is false, the process continues at step 200. If the decision step 202 is true, at step 203, an Embedded Controller (EC) aggregates the provider power which is being delivered across all ports, including USB ports and other ports.

For example, the EC may receive information from Power Delivery controllers regarding the power consumption of the connected devices. At step 204, the EC notifies the BIOS of the aggregated power. BIOS is firmware used to perform hardware initialization during the booting process, and to provide runtime services for operating systems and programs.

The connected devices can include USB Type C device and other devices such as PCIe and Type-A USB devices. BIOS is responsible for aggregating the total power consumed by other devices (either statically allocated or dynamically as in modern PCIe devices) including Type-C as reported by PD/EC. The BIOS then decides whether to keep the mains rails up or switch over to standby rail. BIOS aggregation is applicable in Modern standby. In case of Sx (e.g., S3, S4 and S5), BIOS does not aggregate power or implement policies. Instead, it is left to PD controller or EC to aggregate the total power of the Type-C devices only and decide whether to keep the main rails on.

A decision step 205 determines whether the computer has entered the Modern standby state. If the decision step is true, a decision step 206 determines whether the aggregated power, e.g., from step 203, exceeds an allocated power budget for the standby power rail. If the decision step 206 is true, the BIOS keeps the main rails on at step 208. If the decision step 206 is false, the computer switches to the standby power rail at step 207 and turning off the main power rails. This is the full low power mode.

If the decision step 205 is false, a decision step 209 determines whether the computer has entered the Sx state. If the decision step 209 is true, a decision step 210 determines whether the USB ports are in a provider role. This provides a further check to the check of step 202 after the Sx entry. If the decision step 210 is true, the Power Delivery controller (PD) keeps the main rails on, at step 211. If the decision step 210 is false, step 207 is reached and the computer switches to the standby power rail. Various policies can be implemented as to the use of the main and standby power rails depending on known and estimated power requirements.

Note that the allocated budget can be a function of the low power state. For example, in G3 or S5, the allocated budget could be greater than in other low power states such as S1-S3 because the other loads are in a low power state.

As mentioned, computer systems such as desktop computer systems can have different power states, where entering a low power state (Sx) has traditionally been associated with shutting down the main rails of the ATX while only keeping the standby rail alive. In fact, this power-saving measure is required by some government regulations.

The premise of this requirement and implementation is that all connected input-output (IO) devices are in standby and consuming a standby power, and that associated IP blocks for those devices are in a low power state. An IP block refers to, e.g., a proprietary function or circuit, typically custom made using application specific integrated circuit (ASIC) or field programmable gate array (FPGA) methods.

Consider a USB-C for example. Type-C IP blocks are in a low power state and most of the connected devices over Type-C ports do consume standby power, but there are devices in the market that are not required to adhere to standby requirements or have higher standby power requirements and can potentially consume the full quota of an established power contract. In these scenarios, the policy manager of the USB Power Delivery (PD) controller will need to scale down its power sourcing capability to ensure the overall platform power draw is maintained within the standby power capacity as the main rails turn off. However, this power change disrupts the Type-C port's functionality as a power source, e.g., terminating the charging of a mobile device before it has been fully charged or disabling the support of wake events from devices that have high standby power requirements.

The techniques disclosed herein provide a mechanism to solve this issue by dynamically controlling the ATX rails to ensure the Type-C port's continued ability to operate as a power source during a low power state depending on the usages and intended experiences. This ensures support for Type-C extended use cases such as charging/wake from connected devices while at the same time meeting regulatory requirements.

The techniques disclosed herein provide a mechanism for Embedded Controller (EC), BIOS and Power Delivery (PD) firmware along with a new hardware path implementing glue logic to ensure:
1. The ATX main rails can chose to stay alive as the platform transitions to a low power state (Sx/Modern standby) or use the standby rail depending on the Type-C devices plugged in at the time of transition to the low power state. The ATX main rails can continue to stay alive as the system power enters the low power state when a power-consuming device is attached.
2. The ATX main rails can be turned on within a guaranteed time when a Type-C device is plugged in a low power state.
3. The ATX main rails can be turned off when Type-C Source is no longer needed in a low power state, e.g., by PD communication.

The techniques provide a number of advantages. For example, desktop walk up ports can continue to operate as a power source when the system is in, or is entering, a low power state without exiting the system to active the state. This adds a new functionality to desktop systems in a low power state in at least two areas:
1. Charging devices (e.g., PDPSD (Power Banks), PDUSB (phones, tablets, thin and light laptops)) until they are fully charged before bringing down the main rails and relying on the standby rail.
2. Wake support from devices requiring higher standby power.

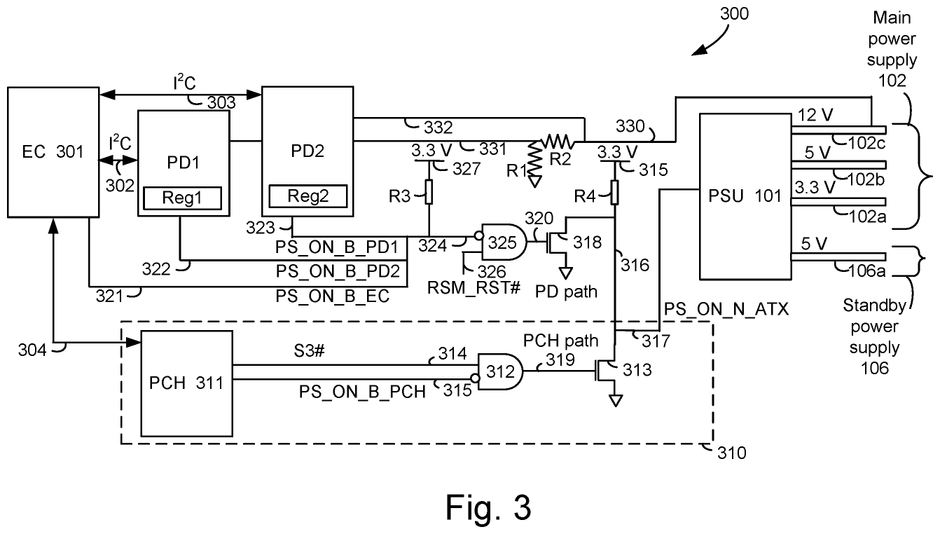

FIG. 3 illustrates an example implementation of a circuit 300 in the computer 100 of FIG. 1 for implementing the process of FIG. 2, in accordance with various embodiments. The circuit includes the PSU 101 of FIG. 1 and its associated main power rails 102a-102c as the main power supply 102 and the standby power rail 106a as the standby power supply. An Embedded Controller 301 is provided which can communicate with one or more Power Delivery (PD) controllers, PD1 and PD2. In this example, there are two such PD controllers, where each is associated with one or more USB ports. For example, PD1 can be associated with the USB ports 120 and 121 and PD2 can be associated with the USB ports 122 and 123, consistent with FIG. 1. Each PD controller may communicate with the EC via a respective I²C link. I²C, or Inter-Integrated Circuit, is a serial bus interface connection protocol. For example, PD1 and PD2 communicate with the EC via I²C links 302 and 303, respectively, to provide information such as the power requirements of the respective connected USB devices.

The ECs may exchange messages with the respective USB devices to establish a contact which specify terms such as the amount of power the device will consume. This is an amount that the devices report they will need during the connection with the host computer. The EC will be able to read the contract established by the USB ports via USB PD messages.

The EC can also communicate with a Platform Controller Hub (PCH) block 310 via a path 304. This block includes a PCH 311 and glue logic including an AND gate 312 and a transistor 313. The PCH comprises circuitry on a motherboard of a computer which can provide an interface between a CPU and peripheral components of the computer. The PCH includes functions such as providing a system clock and providing an interface to an integrated display if present. In some cases, the PCH also provides a Flexible Display Interface (FDI) and a Direct Media Interface (DMI).

The glue logic can be implemented by a USB PD controller signal, PS_ON. The glue logic required to override PS_ON_N_ATX of the ATX power supply includes two paths. A first path is via PCH. This path is used by the BIOS to override PS_ON_N_ATX when entering S0ix (legacy path). A second path is via the PD controllers or the EC on the motherboard. This path is used to override PS_ON_N_ATX when entering Sx/S0ix.

In particular, the PSU 101 provides power on the main power supply when an input signal PS_ON_N_ATX is high. This is the usual condition in the awake state of the computer. The standby power supply may be on or off at this time depending on the policy. For example, the input signal may be provided at 3.3 V via the node 315, resistor R4 and paths 316 and 317. Conversely, the PSU 101 provides power on the standby power supply and not the main power supply when PS_ON_N_ATX is low, e.g., at ground (0 V). For example, PS_ON_N_ATX may be grounded via a transistor 318 and paths 316 and 317 when the transistor turns on. The transistor 318 may be an nMOS which turns on when it receives a high signal at its control gate. At this time, the transistor grounds the paths 316 and 317. PS_ON_N_ATX may also be grounded via a transistor 313 and the path 317 when the transistor 313 turns on. The transistor 313 may be an nMOS which turns on when it receives a high signal (PCH path) at its control gate on path 319.

The PCH provides a signal S3 # on a path 314 to the AND gate 312, and a signal PS_ON_B_PCH on a path 315 to the AND gate. S3 is low when a low power or sleep state is entered. When PS_ON_B_PCH is low, a full low power mode is requested by the PCH. The output of the AND gate on the path 319 is high if S3 # is high and PS_ON_B_PCH is low. This occurs when S3, the inverse of S3 #, is low and PS_ON_B_PCH is low.

Note that the use of a PCH is for this example implementation as other circuitry can be used which provides similar functionality.

As mentioned, the transistor 318 can ground the signal PS_ON_N_ATX. A control gate 320 of the transistor 318 has a value based on signals PS_ON_B_EC, PS_ON_B_PD2 and PS_ON_B_PD1 from the EC 301, PD1 and PD2, respectively, on paths 321, 322 and 323, respectively. The signals from these three paths are combined on a path 324, which is biased by a voltage, e.g., 3.3 V, at a node 327 and a resistor R3. The combined signal is inverted and provided as a first input to an AND gate 325. A reset signal, RSM_RST # is provided as a second input to the AND gate via a path 326. The reset can be asserted to negate the signals of the EC, PD1 and PD2. That is, with RSM_RST asserted high, RSM_RST # is low. The output of the AND gate is therefore low so that PS_ON_N_ATX is not pulled down by the transistor 318.

Assuming RSM_RST is low, and RSM_RST # is high, the transistor 318 will not pulldown PS_ON_N_ATX if each of the signals PS_ON_B_EC, PS_ON_B_PD2 and PS_ON_B_PD1 is also high or not-asserted. On the other hand, the transistor 318 will pulldown PS_ON_N_ATX if any of the signals PS_ON_B_EC, PS_ON_B_PD2 and PS_ON_B_PD1 is low/asserted. Accordingly, each of the EC, PD1 and PD2 have the ability to keep the main power supply on even if a low power state such as S3 has been entered.

In this example hardware implementation, the PCH path is a legacy path which is already present in the computer to support keeping ATX main rails up in S0ix. The paths from the EC, PD1 and PD2 are used in addition to the legacy path to provide an enhanced USB-C user experience. These paths can be used to keep ATX in a low power state in both Sx (e.g., S3, S4 or S5) and S0ix (Modern standby). A general purpose input-output (GPIO) from each PD controller is OR'ed together at the path 324 and if any of them is asserted (low) in a PS_ON_N_ATX override condition, the AND gate 325 turns on the control FET (transistor 318) to assert ATX PS_ON_N_ATX to keep the main rails alive in a low power entry condition. A power switch is recommended to disconnect each of the ATX mains rails from the rest of the platform so that they remain off in low power entry. A 12 V input to the PD controllers notifies them when the main rails are active (up). The PD controllers rely on this notification during G3 to negotiate a high power contract with port partners until the main rails are active. For example, 12 V power from the main rail 102c can be provided to PD1 via path 330, resistor R2 and path 331, and to PD2 via paths 330 and 332. The path 331 is coupled to ground via a resistor R1.

A general-purpose input/output (GPIO) can be an uncommitted digital signal pin on an integrated circuit or electronic circuit board which may be used as an input or output, or both, and is controllable by the user at runtime.

The BIOS firmware may have a provision to override PCH from driving PS_ON_B_PCH low only during Modern standby entry depending on the total power consumption of the connected I/O devices.

Type-C can OPT-IN for overriding PS_ON_N_ATX during Modern standby by notifying BIOS of the total consumed power of the connected devices or it can override PS_ON_N_ATX independent of the PCH as in the case of Sx. During BIOS OPT-IN, the EC 301 aggregates the power consumption of all Type-C connected devices and notifies BIOS. If the connected Type-C devices consume more than an allocated power budget, e.g., 4.5 W, the BIOS would request the PCH to override PS_ON_N_ATX by keeping PS_ON_B_PCH from being driven low. 4.5 W is an example value of an arbitrary power budget allocated to USB-C/Type-C devices depending on the overall budget of the standby rail. Note that, in addition the external USB and other components, internal components such as RAM can consume power from the standby rail. Moreover, the RAM size is variable by configuration so that its power consumption is not fixed. As an example, if the allocated budget is 10 W for the standby rail and a single USB device is rated to consume 4.5 W, there may or may not be enough remaining power budget to safely accommodate the RAM power consumption. On the other hand, a USB device operating in a suspend mode will consume less than 12.5 mW, barely reducing the allocated budget. In another example, a device such as a phone may consume 15 W which clearly cannot be accommodated by the standby rail in this example. A policy decision can be made as to when it is advisable to keep the main power rails on. The power budget in the full low power mode should consider all of these factors and leave enough power for the system to operate.

The PD can also decide to override PS_ON_N_ATX independent of PS_ON_B_PCH by driving PS_ON_B_PD low. This independent mechanism of controlling the ATX power rails could be used mostly in Sx but can also be implemented to meet regulatory requirements during Modern standby. The policy for overriding PS_ON_N can be set by the PD controller. The EC can notify the PD controllers of platform low power transitions such as Sx or Modern standby. This is achieved through host interface registers Reg1 and Reg2 of PD1 and PD2, respectively, which can be accessed by the EC via the I²C interfaces or links 302 and 303. The registers can expose the ACPI power states that the EC can use to notify low power entry and exit.

Note that while the ATX was discussed, the techniques are applicable to other motherboard and power supply configuration specifications. Also, while the USB-C connector was discussed, the techniques are applicable to other connector standards.

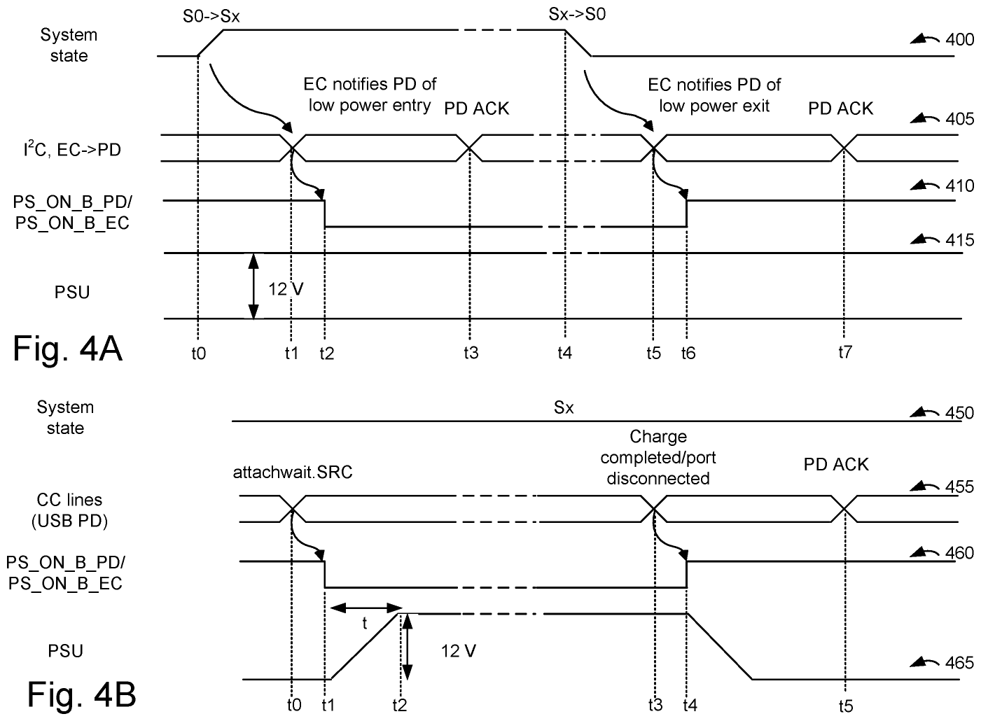

FIG. 4A illustrates example signals consistent with the process of FIG. 2 and the computer implementation of FIG. 3 in accordance with various embodiments, where there is a transition from an awake state to a modified low power state and back to the awake state. As mentioned, the PD host interface registers can expose the ACPI power states that the EC can use to notify low power entry and exit. The PD controllers in turn rely on this notification to implement policies that determine if the ATX needs to retain its main power rail or switch to the standby rail. While the system is in a low power state, the PD controller can also turn ON the ATX main rails depending on the type of device attached. As an example, a mobile phone attached to a port for charging may trigger the PD to turn ON the rails. Once the phone is completely charged, the rails can be turned OFF.

As mentioned, a low power state can be triggered, e.g., based on lack of user input or based on a user command. Modern standby entry and Sx entry can be initiated by the user. For example, the user can initiate Sx entry from Windows and is equivalent to “Sleep—S3”, “Hibernate—S4”, “Shutdown—S5”. “Modern standby” is the S0ix state and may be entered if the computer is inactive, e.g., the user has not provided an input for a specified period of time.

For example, a plot 400 depicts a system state, e.g., S0 (awake or full power) or Sx (sleep or low power). A plot 405 depicts a signal on the I²C link between the EC and a PD controller. A plot 410 depicts PS_ON_B or PS_ON_B_EC from FIG. 3. A plot 415 depicts an output voltage of the PSU at 12 V. The state transitions from S0 to Sx at t0. In response to this transition, the EC notifies one or more PD controllers of the low power entry at t1. The PD controllers provide an acknowledgement (ACK) at t3. Further, the EC or PD controllers trigger an active low level of PS_ON_B or PS_ON_B_EC, respectively, from t2-t6. This ensures the main rails stay on, in a modified low power state.

At t4, the state transitions back from Sx to S0. In response to this transition, the EC notifies the PD controllers of the low power exit at t5. The PD controllers provide an acknowledgement (ACK) at t7. Further, the EC or PD controllers trigger an inactive high level of PS_ON_B or PS_ON_B_EC, respectively, at t6. The main rails remain on, but now in the awake or full power state. The 12 V output of the PSU, along with other main supply rail outputs such as 5 V and 3.3 V, remain on throughout the time period depicted (t0-t7). The non-essential internal components are turned off during the Sx state, from t0-t4.

FIG. 4B illustrates example signals consistent with the process of FIG. 2 and the computer implementation of FIG. 3 in accordance with various embodiments, where there is a transition from a full low power state to a modified low power state and back to the full low power state. A plot 450 depicts the system state, which remains at Sx (sleep or low power) in this example. A plot 455 depicts a signal on configuration channel (CC) lines of the USB PD controllers. For the USB Type-C solution, two pins on the connector, CC1 and CC2, are used to establish and manage the Source-to-Sink connection. The configuration channel is used to detect the attachment of USB ports, e.g. a Source to a Sink, resolve cable orientation and twist connections to establish USB data bus routing, establish data roles between two attached ports, discover and configure VBUS: USB Type-C Current modes or USB Power Delivery, configure VCONN and discover and configure optional Alternate and Accessory modes.

A plot 460 depicts PS_ON_B or PS_ON_B_EC from FIG. 3. A plot 465 depicts a voltage output of the PSU. At t0, the PD controller is in an “attachwait.src” state. This state is entered when a USB device is plugged into a Type C port, for example. The PD controller for the port will follow a protocol in which it waits for a period of time after detecting a current sinking device being plugged in. Once the period of time has passed, such as 200 msec., the connection is confirmed.

In response to the attachwait.src state, the EC or PD controllers trigger an active low level of PS_ON_B or PS_ON_B_EC, respectively, from t1-t4. This ensures the main rails turn on, in a modified low power state. In particular, the output of the PSU increases from 0 V to 12 V in a time period t. At t3, the plot 455 indicates the USB device has completed charging and is disconnected from the port. In response, the EC or PD controllers trigger an inactive high level of PS_ON_B or PS_ON_B_EC, respectively, at t4. This causes the PSU to transition its output from 12 V back to 0 V. In this case, the computer returns to the full low power state. The temporary overriding of the full low power state by the EC or PD controllers is completed. The PD controllers provide an acknowledgement at t5.

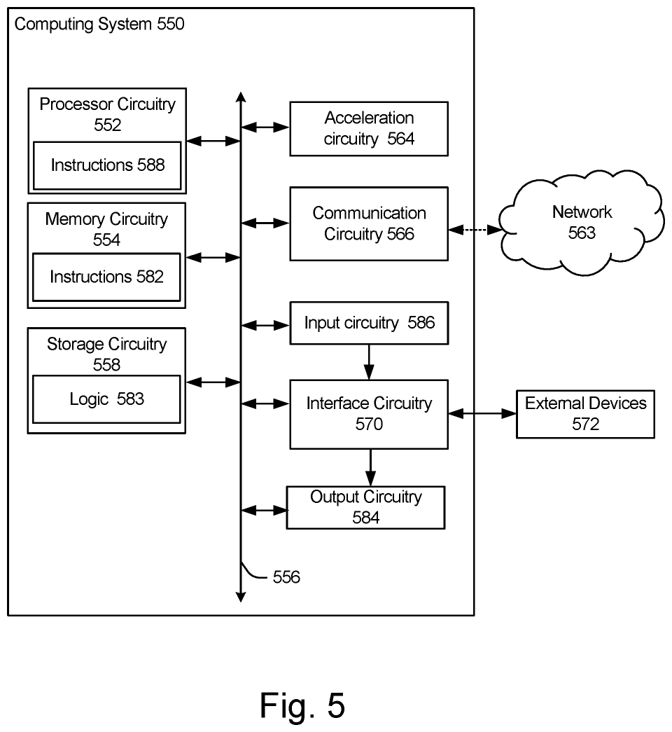

FIG. 5 illustrates an example of components that may be present in a computing system 550 for implementing the techniques (e.g., operations, processes, methods, and methodologies) described herein.

The computing system 550 may include any combinations of the hardware or logical components referenced herein. The components may be implemented as ICs, portions thereof, discrete electronic devices, or other modules, instruction sets, programmable logic or algorithms, hardware, hardware accelerators, software, firmware, or a combination thereof adapted in the computing system 550, or as components otherwise incorporated within a chassis of a larger system. For one embodiment, at least one processor 552 may be packaged together with computational logic 582 and configured to practice aspects of various example embodiments described herein to form a System in Package (SiP) or a System on Chip (SoC).

The system 550 includes processor circuitry in the form of one or more processors 552. The processor circuitry 552 includes circuitry such as, but not limited to one or more processor cores and one or more of cache memory, low drop-out voltage regulators (LDOs), interrupt controllers, serial interfaces such as SPI, I²C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 552 may include one or more hardware accelerators (e.g., same or similar to acceleration circuitry 564), which may be microprocessors, programmable processing devices (e.g., FPGA, ASIC, etc.), or the like. The one or more accelerators may include, for example, computer vision and/or deep learning accelerators. In some implementations, the processor circuitry 552 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein

The processor circuitry 552 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low voltage processor, an embedded processor, or any other known processing elements, or any suitable combination thereof. The processors (or cores) 552 may be coupled with or may include memory/storage and may be configured to execute instructions stored in the memory/storage to enable various applications or operating systems to run on the platform 550. The processors (or cores) 552 is configured to operate application software to provide a specific service to a user of the platform 550. In some embodiments, the processor(s) 552 may be a special-purpose processor(s)/controller(s) configured (or configurable) to operate according to the various embodiments herein.

As examples, the processor(s) 552 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, Calif. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 552 may be a part of a system on a chip (SoC), System-in-Package (SiP), a multi-chip package (MCP), and/or the like, in which the processor(s) 552 and other components are formed into a single integrated circuit, or a single package, such as the Edison™ or Galileo™ SoC boards from Intel® Corporation. Other examples of the processor(s) 552 are mentioned elsewhere in the present disclosure.

The system 550 may include or be coupled to acceleration circuitry 564, which may be embodied by one or more AI/ML accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as complex (CPLDs) or high complexity PLDs (HCPLDs), and/or other forms of specialized processors or circuitry designed to accomplish one or more specialized tasks. These tasks may include AI/ML processing (e.g., including training, inferencing, and classification operations), visual data processing, network data processing, object detection, rule analysis, or the like. In FPGA-based implementations, the acceleration circuitry 564 may comprise logic blocks or logic fabric and other interconnected resources that may be programmed (configured) to perform various functions, such as the procedures, methods, functions, etc. of the various embodiments discussed herein. In such implementations, the acceleration circuitry 564 may also include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 552 and/or acceleration circuitry 564 may include hardware elements specifically tailored for machine learning and/or artificial intelligence (AI) functionality. In these implementations, the processor circuitry 552 and/or acceleration circuitry 564 may be, or may include, an AI engine chip that can run many different kinds of AI instruction sets once loaded with the appropriate weightings and training code. Additionally or alternatively, the processor circuitry 552 and/or acceleration circuitry 564 may be, or may include, AI accelerator(s), which may be one or more of the aforementioned hardware accelerators designed for hardware acceleration of AI applications. As examples, these processor(s) or accelerators may be a cluster of artificial intelligence (AI) GPUs, tensor processing units (TPUs) developed by Google® Inc., Real AI Processors (RAPs™) provided by AlphaICs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 552 and/or acceleration circuitry 564 and/or hardware accelerator circuitry may be implemented as AI accelerating co-processor(s), such as the Hexagon 685 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the HiSilicon Kirin 970 provided by Huawei®, and/or the like. In some hardware-based implementations, individual subsystems of system 550 may be operated by the respective AI accelerating co-processor(s), AI GPUs, TPUs, or hardware accelerators (e.g., FPGAs, ASICs, DSPs, SoCs, etc.), etc., that are configured with appropriate logic blocks, bit stream(s), etc. to perform their respective functions.

The system 550 also includes system memory 554. Any number of memory devices may be used to provide for a given amount of system memory. As examples, the memory 554 may be, or include, volatile memory such as random access memory (RAM), static RAM (SRAM), dynamic RAM (DRAM), synchronous DRAM (SDRAM), RAMBUS® Dynamic Random Access Memory (RDRAM®), and/or any other desired type of volatile memory device. Additionally or alternatively, the memory 554 may be, or include, non-volatile memory such as read-only memory (ROM), erasable programmable ROM (EPROM), electrically erasable programmable (EEPROM), flash memory, non-volatile RAM, ferroelectric RAM, phase-change memory (PCM), flash memory, and/or any other desired type of non-volatile memory device. Access to the memory 554 is controlled by a memory controller. The individual memory devices may be of any number of different package types such as single die package (SDP), dual die package (DDP) or quad die package (Q17P). Any number of other memory implementations may be used, such as dual inline memory modules (DIMMs) of different varieties including but not limited to microDIMMs or MiniDIMMs.

Storage circuitry 558 provides persistent storage of information such as data, applications, operating systems and so forth. In an example, the storage 558 may be implemented via a solid-state disk drive (SSDD) and/or high-speed electrically erasable memory (commonly referred to as “flash memory”). Other devices that may be used for the storage 558 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, a hard disk drive (HDD), micro HDD, of a combination thereof, and/or any other memory. The memory circuitry 554 and/or storage circuitry 558 may also incorporate three-dimensional (3D) cross-point (XPOINT) memories from Intel® and Micron®.

The memory circuitry 554 and/or storage circuitry 558 is/are configured to store computational logic 583 in the form of software, firmware, microcode, or hardware-level instructions to implement the techniques described herein. The computational logic 583 may be employed to store working copies and/or permanent copies of programming instructions, or data to create the programming instructions, for the operation of various components of system 500 (e.g., drivers, libraries, application programming interfaces (APIs), etc.), an operating system of system 500, one or more applications, and/or for carrying out the embodiments discussed herein. The computational logic 583 may be stored or loaded into memory circuitry 554 as instructions 582, or data to create the instructions 582, which are then accessed for execution by the processor circuitry 552 to carry out the functions described herein. The processor circuitry 552 and/or the acceleration circuitry 564 accesses the memory circuitry 554 and/or the storage circuitry 558 over the interconnect (IX) 556. The instructions 582 direct the processor circuitry 552 to perform a specific sequence or flow of actions, for example, as described with respect to flowchart(s) and block diagram(s) of operations and functionality depicted previously. The various elements may be implemented by assembler instructions supported by processor circuitry 552 or high-level languages that may be compiled into instructions 581, or data to create the instructions 581, to be executed by the processor circuitry 552. The permanent copy of the programming instructions may be placed into persistent storage devices of storage circuitry 558 in the factory or in the field through, for example, a distribution medium (not shown), through a communication interface (e.g., from a distribution server (not shown)), over-the-air (OTA), or any combination thereof.

The IX 556 couples the processor 552 to communication circuitry 566 for communications with other devices, such as a remote server (not shown) and the like. The communication circuitry 566 is a hardware element, or collection of hardware elements, used to communicate over one or more networks 563 and/or with other devices. In one example, communication circuitry 566 is, or includes, transceiver circuitry configured to enable wireless communications using any number of frequencies and protocols such as, for example, the Institute of Electrical and Electronics Engineers (IEEE) 802.11 (and/or variants thereof), IEEE 802.23.4, Bluetooth® and/or Bluetooth® low energy (BLE), ZigBee®, LoRaWAN™ (Long Range Wide Area Network), a cellular protocol such as 3GPP LTE and/or Fifth Generation (5G)/New Radio (NR), and/or the like. Additionally or alternatively, communication circuitry 566 is, or includes, one or more network interface controllers (NICs) to enable wired communication using, for example, an Ethernet connection, Controller Area Network (CAN), Local Interconnect Network (LIN), DeviceNet, ControlNet, Data Highway+, or PROFINET, among many others.

The IX 556 also couples the processor 552 to interface circuitry 570 that is used to connect system 550 with one or more external devices 572. The external devices 572 may include, for example, sensors, actuators, positioning circuitry (e.g., global navigation satellite system (GNSS)/Global Positioning System (GPS) circuitry), client devices, servers, network appliances (e.g., switches, hubs, routers, etc.), integrated photonics devices (e.g., optical neural network (ONN) integrated circuit (IC) and/or the like), and/or other like devices.

In some optional examples, various input/output (I/O) devices may be present within or connected to, the system 550, which are referred to as input circuitry 586 and output circuitry 584 in FIG. 5. The input circuitry 586 and output circuitry 584 include one or more user interfaces designed to enable user interaction with the platform 550 and/or peripheral component interfaces designed to enable peripheral component interaction with the platform 550. Input circuitry 586 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 584 may be included to show information or otherwise convey information, such as sensor readings, actuator position(s), or other like information. Data and/or graphics may be displayed on one or more user interface components of the output circuitry 584. Output circuitry 584 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Crystal Displays (LCD), LED displays, quantum dot displays, projectors, etc.), with the output of characters, graphics, multimedia objects, and the like being generated or produced from the operation of the platform 550. The output circuitry 584 may also include speakers and/or other audio emitting devices, printer(s), and/or the like. Additionally or alternatively, sensor(s) may be used as the input circuitry 584 (e.g., an image capture device, motion capture device, or the like) and one or more actuators may be used as the output device circuitry 584 (e.g., an actuator to provide haptic feedback or the like). Peripheral component interfaces may include, but are not limited to, a non-volatile memory port, a USB port, an audio jack, a power supply interface, etc. In some embodiments, a display or console hardware, in the context of the present system, may be used to provide output and receive input of an edge computing system; to manage components or services of an edge computing system; identify a state of an edge computing component or service; or to conduct any other number of management or administration functions or service use cases.

The components of the system 550 may communicate over the IX 556. The IX 556 may include any number of technologies, including ISA, extended ISA, I2C, SPI, point-to-point interfaces, power management bus (PMBus), PCI, PCIe, PCIx, Intel® UPI, Intel® Accelerator Link, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, PROFIBUS, and/or any number of other IX technologies. The IX 556 may be a proprietary bus, for example, used in a SoC based system.

The number, capability, and/or capacity of the elements of system 500 may vary, depending on whether computing system 500 is used as a stationary computing device (e.g., a server computer in a data center, a workstation, a desktop computer, etc.) or a mobile computing device (e.g., a smartphone, tablet computing device, laptop computer, game console, IoT device, etc.). In various implementations, the computing device system 500 may comprise one or more components of a data center, a desktop computer, a workstation, a laptop, a smartphone, a tablet, a digital camera, a smart appliance, a smart home hub, a network appliance, and/or any other device/system that processes data.

The techniques described herein can be performed partially or wholly by software or other instructions provided in a machine-readable storage medium (e.g., memory). The software is stored as processor-executable instructions (e.g., instructions to implement any other processes discussed herein). Instructions associated with the flowchart (and/or various embodiments) and executed to implement embodiments of the disclosed subject matter may be implemented as part of an operating system or a specific application, component, program, object, module, routine, or other sequence of instructions or organization of sequences of instructions.

The storage medium can be a tangible machine readable medium such as read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs)), among others.

The storage medium may be included, e.g., in a communication device, a computing device, a network device, a personal digital assistant, a manufacturing tool, a mobile communication device, a cellular phone, a notebook computer, a tablet, a game console, a set top box, an embedded system, a TV (television), or a personal desktop computer.

Some non-limiting examples of various embodiments are presented below.

Example 1 includes an apparatus, comprising: a power supply unit configured to provide a main power supply and a standby power supply; one or more ports coupled to the main power supply and the standby power supply, the one or more ports are to connect to one or more external devices; and circuitry coupled to the power supply unit and the one or more ports, the circuitry is to determine a power consumption of the one or more external devices and determine, based on the power consumption, whether to power the one or more external devices with the main power supply or the standby power supply in a low power mode.

Example 2 includes the apparatus of Example 1, wherein the circuitry is to turn off non-essential internal components when the one or more external devices are powered with the main power supply in the low power mode.

Example 3 includes the apparatus of Examples 1 and 2, wherein the circuitry is to power the one or more external devices with the main power supply in the low power mode when the power consumption exceeds an allocated power budget.

Example 4 includes the apparatus of Examples 1-3, wherein the circuitry is to power the one or more external devices with the standby power supply in the low power mode when the power consumption does not exceed the allocated power budget.

Example 5 includes the apparatus of Examples 1-4, further comprising: a platform controller hub coupled to the power supply unit, wherein the platform controller hub is to provide a signal to turn off the main power supply in the low power mode, and the circuitry, to power the one or more external devices with the main power supply in the low power mode, is to override the signal.

Example 6 includes the apparatus of Examples 1-5, wherein: the circuitry comprises one or more power delivery controllers coupled to the power supply unit; the one or more power delivery controllers are to communicate with the one or more external devices via the one or more ports to determine the power consumption of the one or more external devices; and to power the one or more external devices with the main power supply in the low power mode, the one or more power delivery controllers are to override a signal to turn off the main power supply.

Example 7 includes the apparatus of Example 6, wherein: the one or more external devices comprise a plurality of external devices; the one or more ports comprise a plurality of ports; the one or more power delivery controllers comprise at least a first power delivery controller and a second power delivery controller; and to determine the power consumption of the one or more external devices: the first power delivery controller is to communicate with a first subset of the plurality of external devices via a corresponding first subset of the plurality of ports to determine a power consumption of the first subset of the plurality of external devices; and the second power delivery controller is to communicate with a second subset of the plurality of external devices via a corresponding second subset of the plurality of ports to determine a power consumption of the second subset of the external devices.

Example 8 includes the apparatus of Examples 6 and 7, wherein the one or more power delivery controllers are coupled to the main power supply to detect when the main power supply is turned on.

Example 9 includes the apparatus of Examples 6-8, wherein: the one or more external devices comprise a plurality of external devices; the circuitry comprises an embedded controller coupled to the one or more power delivery controllers; and the embedded controller is to receive information from the one or more power delivery controllers indicating a power consumption of each external device of the plurality of external devices, to aggregate the power consumption of each external device to obtain an aggregated power consumption and to use the aggregated power consumption as the power consumption to determine whether to power the one or more external devices with the main power supply or the standby power supply in the low power mode.

Example 10 includes the apparatus of Examples 1-9, wherein: the low power mode comprises a Modern standby mode.

Example 11 includes the apparatus of Examples 1-10, wherein: the circuitry is to determine the power consumption of the one or more external devices in response to a determination that the one or more ports are in a power provider role.

Example 12 includes an apparatus, comprising: one or more ports coupled to a main power supply and to a standby power supply of a power supply unit, the one or more ports are to connect to one or more external devices; and circuitry coupled to the power supply unit and the one or more ports, the circuitry is to make a determination that a low power state is entered and, in response to the determination that the low powered state is entered, make a determination of whether the one or more ports are in a power provider role, and when the one or more ports are in the power provider role, override a signal to turn off the main power supply to thereby allow the one or more external devices to be powered with the main power supply.

Example 13 includes the apparatus of Example 12, wherein: when the one or more ports are not in the power provider role, the circuitry is to not override the signal to turn off the main power supply, to thereby allow the one or more external devices to be powered with the standby power supply.

Example 14 includes the apparatus of Example 12 or 13, wherein: the one or more external devices comprise USB type C devices.

Example 15 includes the apparatus of Examples 12-14, wherein: the low power mode comprises an S3 mode.

Example 16 includes the apparatus of Examples 12-15, wherein: the circuitry comprises one or more power delivery controllers coupled to the power supply unit; and the one or more power delivery controllers are to communicate with the one or more external devices via the one or more ports to make the determination of whether the one or more ports are in a power provider role.

Example 17 includes the apparatus of Examples 12-16, wherein: the one or more external devices comprise a plurality of external devices; the one or more ports comprise a plurality of ports; the one or more power delivery controllers comprise at least a first power delivery controller and a second power delivery controller; and to make the determination of whether the one or more ports are in the power provider role: the first power delivery controller is to communicate with a first subset of the plurality of external devices via a corresponding first subset of the plurality of ports to make a determination of whether the first subset of the plurality of ports are in the power provider role; and the second power delivery controller is to communicate with a second subset of the plurality of external devices via a corresponding second subset of the plurality of ports to make a determination of whether the second subset of the plurality of ports are in the power provider role.

Example 18 includes an apparatus, comprising: a platform controller hub to send a signal to a power supply unit to turn off a main power supply of the power supply when a computer enters a low power state; and a power delivery controller coupled to the power supply unit, the power delivery controller to make a determination of whether to override the signal, to thereby keep the main power supply turned on, wherein to make the determination, the power delivery controller is to determine a presence of one or more external devices connected to one or more ports of the computer.

Example 19 includes the apparatus of Example 18, wherein: to make the determination, the power delivery controller is to determine a power consumption of the one or more external devices.

Example 20 includes the apparatus of Examples 18 and 19, wherein: to make the determination, the power delivery controller is to determine whether the one or more ports are in a power provider role.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. An apparatus, comprising:
a power supply unit configured to provide a main power supply and a standby power supply;
one or more ports coupled to the main power supply and the standby power supply, the one or more ports are to connect to one or more external devices; and
circuitry coupled to the power supply unit and the one or more ports, the circuitry is to determine a power consumption of the one or more external devices and determine, based on the power consumption, whether to power the one or more external devices with the main power supply or the standby power supply in a low power mode.

2. The apparatus of claim 1, wherein:
the circuitry is to turn off non-essential internal components when the one or more external devices are powered with the main power supply in the low power mode.

3. The apparatus of claim 1, wherein:
the circuitry is to power the one or more external devices with the main power supply in the low power mode when the power consumption exceeds an allocated power budget.

4. The apparatus of claim 1, wherein:
the circuitry is to power the one or more external devices with the standby power supply in the low power mode when the power consumption does not exceed the allocated power budget.

5. The apparatus of claim 1, further comprising:
a platform controller hub coupled to the power supply unit, wherein the platform controller hub is to provide a signal to turn off the main power supply in the low power mode and the circuitry, to power the one or more external devices with the main power supply in the low power mode, is to override the signal.

6. The apparatus of claim 1, wherein:
the circuitry comprises one or more power delivery controllers coupled to the power supply unit;
the one or more power delivery controllers are to communicate with the one or more external devices via the one or more ports to determine the power consumption of the one or more external devices; and
to power the one or more external devices with the main power supply in the low power mode, the one or more power delivery controllers are to override a signal to turn off the main power supply.

7. The apparatus of claim 6, wherein:
the one or more external devices comprise a plurality of external devices;
the one or more ports comprise a plurality of ports;
the one or more power delivery controllers comprise at least a first power delivery controller and a second power delivery controller; and
to determine the power consumption of the one or more external devices:
the first power delivery controller is to communicate with a first subset of the plurality of external devices via a corresponding first subset of the plurality of ports to determine a power consumption of the first subset of the plurality of external devices; and
the second power delivery controller is to communicate with a second subset of the plurality of external devices via a corresponding second subset of the plurality of ports to determine a power consumption of the second subset of the external devices.

8. The apparatus of claim 6, wherein:
the one or more power delivery controllers are coupled to the main power supply to detect when the main power supply is turned on.

9. The apparatus of claim 6, wherein:
the one or more external devices comprise a plurality of external devices;
the circuitry comprises an embedded controller coupled to the one or more power delivery controllers; and
the embedded controller is to receive information from the one or more power delivery controllers indicating a power consumption of each external device of the plurality of external devices, to aggregate the power consumption of each external device to obtain an aggregated power consumption and to use the aggregated power consumption as the power consumption to determine whether to power the one or more external devices with the main power supply or the standby power supply in the low power mode.

10. The apparatus of claim 1, wherein:
the low power mode comprises a Modern standby mode.

11. The apparatus of claim 1, wherein:
the circuitry is to determine the power consumption of the one or more external devices in response to a determination that the one or more ports are in a power provider role.

12. An apparatus, comprising:
one or more ports coupled to a main power supply and to a standby power supply of a power supply unit, the one or more ports are to connect to one or more external devices; and
circuitry coupled to the power supply unit and the one or more ports, the circuitry is to make a determination that a low power state is entered and, in response to the determination that the low powered state is entered, make a determination of whether the one or more ports are in a power provider role, and when the one or more ports are in the power provider role, override a signal to turn off the main power supply to thereby allow the one or more external devices to be powered with the main power supply.

13. The apparatus of claim 12, wherein:
when the one or more ports are not in the power provider role, the circuitry is to not override the signal to turn off the main power supply, to thereby allow the one or more external devices to be powered with the standby power supply.

14. The apparatus of claim 12, wherein:
the one or more external devices comprise USB type C devices.

15. The apparatus of claim 12, wherein:
the low power mode comprises an S3 mode.

16. The apparatus of claim 12, wherein:
the circuitry comprises one or more power delivery controllers coupled to the power supply unit; and
the one or more power delivery controllers are to communicate with the one or more external devices via the one or more ports to make the determination of whether the one or more ports are in a power provider role.

17. The apparatus of claim 12, wherein:
the one or more external devices comprise a plurality of external devices;
the one or more ports comprise a plurality of ports;
the one or more power delivery controllers comprise at least a first power delivery controller and a second power delivery controller; and
to make the determination of whether the one or more ports are in the power provider role:
the first power delivery controller is to communicate with a first subset of the plurality of external devices via a corresponding first subset of the plurality of ports to make a determination of whether the first subset of the plurality of ports are in the power provider role; and
the second power delivery controller is to communicate with a second subset of the plurality of external devices via a corresponding second subset of the plurality of ports to make a determination of whether the second subset of the plurality of ports are in the power provider role.

18. An apparatus, comprising:
a platform controller hub to send a signal to a power supply unit to turn off a main power supply of the power supply when a computer enters a low power state; and
a power delivery controller coupled to the power supply unit, the power delivery controller to make a determination of whether to override the signal, to thereby keep the main power supply turned on, wherein to make the determination, the power delivery controller is to determine a presence of one or more external devices connected to one or more ports of the computer.

19. The apparatus of claim 18, wherein:
to make the determination, the power delivery controller is to determine a power consumption of the one or more external devices.

20. The apparatus of claim 18, wherein:
to make the determination, the power delivery controller is to determine whether the one or more ports are in a power provider role.
